(19) United States
(12) Patent Application Publication
(10) Pub. No.: US 2025/0103250 A1
(43) Pub. Date: Mar. 27, 2025

(54) INFORMATION PROCESSING SYSTEM, IMAGE FORMING APPARATUS, AND NON-TRANSITORY COMPUTER READABLE MEDIUM

(71) Applicant: FUJIFILM Business Innovation Corp., Tokyo (JP)

(72) Inventor: Tomohiro SEKO, Kanagawa (JP)

(73) Assignee: FUJIFILM Business Innovation Corp., Tokyo (JP)

(21) Appl. No.: 18/605,831

(22) Filed: Mar. 15, 2024

(30) Foreign Application Priority Data
Sep. 26, 2023 (JP) 2023-163640

(51) Int. Cl. G06F 3/12

(52) U.S. Cl. CPC G06F 3/1205; G06F 3/1257; G06F 3/1258

(57) ABSTRACT

An information processing system includes a memory configured to store property information about one or plural types of recording media; and one or plural processors configured to: acquire property information about a target recording medium; display, on a display, a scatter chart indicating distribution of properties of the recording media for which the property information is stored in the memory and properties of the target recording medium; and display, on the same screen as a screen on which the scatter chart is displayed or on a screen different from the screen on which the scatter chart is displayed, an operation setting of an image forming apparatus for one of the recording media indicated in the scatter chart.

### CROSS-REFERENCE TO RELATED APPLICATIONS

This application is based on and claims priority under 35 USC 119 from Japanese Patent Application No. 2023-163640 filed Sep. 26, 2023.

### BACKGROUND

### (i) Technical Field

The present disclosure relates to an information processing system, an image forming apparatus, and a non-transitory computer readable medium.

### (ii) Related Art

An image forming apparatus holds settings for printing parameters such as transfer voltage and fixing temperature for each type of a recording medium such as paper. Furthermore, the image forming apparatus receives changes of settings for printing parameters by a user.

In Japanese Unexamined Patent Application Publication No. 2023-107322, an image forming apparatus that holds, for each type of paper, information about a first image forming speed for image formation in a first operation mode a second image forming speed for image formation in a second operation mode, stores a setting value for changing an image forming speed when operating in the second operation mode, performs image formation at the first image forming speed based on the type of paper when operating in the first operation mode, and performs image formation at a speed set by changing, according to the setting value, the second image forming speed based on the type of paper when operating in the second mode, is disclosed. Japanese Unexamined Patent Application Publication No. 2023-107322 also discloses the feature that a user is able to change transfer voltage and fixing temperature, which are parameters.

### SUMMARY

In the case where an operation setting (printing parameter) of the image forming apparatus for a recording medium that the user wishes to use is not provided, it is difficult for the user to set an appropriate operation setting.

Aspects of non-limiting embodiments of the present disclosure relate to enabling operation settings to be set based on the type of a recording medium more easily than a configuration in which a user sets operation settings of an image forming apparatus on the basis of experience and knowledge of the user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a memory configured to store property information about one or a plurality of types of recording media; and one or a plurality of processors configured to: acquire property information about a target recording medium; display, on a display, a scatter chart indicating distribution of properties of the recording media for which the property information is stored in the memory and properties of the target recording medium; and display, on the same screen as a screen on which the scatter chart is displayed or on a screen different from the screen on which the scatter chart is displayed, an operation setting of an image forming apparatus for one of the recording media indicated in the scatter chart.

### BRIEF DESCRIPTION OF THE DRAWINGS

Exemplary embodiments of the present disclosure will be described in detail based on the following figures, wherein:

FIG. 1 is a diagram illustrating a configuration of an image forming apparatus according to an exemplary embodiment;

FIG. 2 is a diagram illustrating an example of the hardware configuration of an information processing unit;

FIG. 3A is a diagram illustrating a table in which property information about paper is registered;

FIG. 3B is a scatter chart illustrating an example of a result of clustering of paper;

FIG. 4A is a diagram illustrating a property information table;

FIG. 4B is a scatter chart illustrating a result of clustering;

FIG. 5A is a diagram illustrating a basic screen;

FIG. 5B is a diagram illustrating an example of an operation screen for receiving a change of an operation setting;

FIG. 5C is a diagram illustrating another example of the operation screen for receiving a change of an operation setting;

FIG. 6A is a diagram illustrating a property information table;

FIG. 6B is a scatter chart illustrating a result of clustering;

FIG. 7A is a diagram illustrating a basic screen;

FIG. 7B is a diagram illustrating an example of an operation screen for receiving a change of an operation setting;

FIG. 7C is a diagram illustrating another example of the operation screen for receiving a change of an operation setting; and

FIG. 8 is a flowchart illustrating an operation of the information processing unit.

### DETAILED DESCRIPTION

Hereinafter, an exemplary embodiment of the present disclosure will be described in detail with reference to the attached drawings.

### <System Configuration>

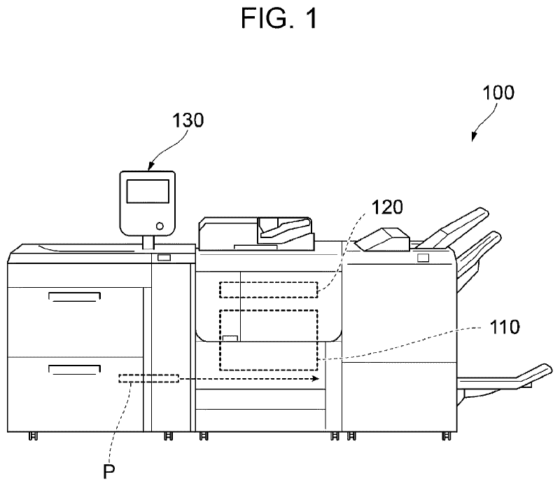

FIG. 1 is a diagram illustrating a configuration of an image forming apparatus according to an exemplary embodiment. An image forming apparatus 100 includes an image forming unit 110, an information processing unit 120, and a display unit 130.

The image forming unit 110 forms on a recording medium such as paper P an image based on image data by using an image forming material. As a method for forming an image on a recording medium, for example, an electrophotographic system for forming an image by transferring toner attached to a photoreceptor to a recording material, an inkjet system for forming an image by discharging ink to a recording material, or the like is used. Hereinafter, an example in which the electrophotographic system is used as an image forming method will be described. Furthermore, an example in which paper is used as a recording medium will be described. In the description provided below, forming an image on paper as a recording medium will be referred to as “printing”.

The information processing unit 120 performs various types of processing for the image forming apparatus 100. Specifically, the information processing unit 120 performs processing of controlling an image forming operation by the image forming unit 110 and setting, processing such as correction of an image to be output, and processing such as image display control of the display unit 130.

The display unit 130 displays a screen for providing various types of information about the image forming apparatus 100 to a user and an operation screen for receiving an operation for the image forming apparatus 100. The display screen of the display unit 130 may be a touch panel for receiving a touch operation on the operation screen by the user.

### <Configuration of Information Processing Unit 120>

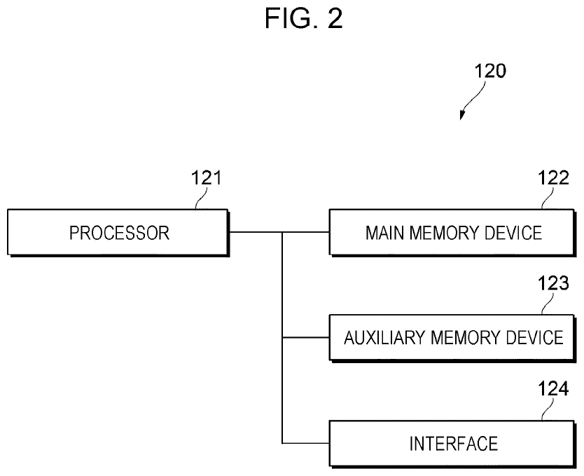

FIG. 2 is a diagram illustrating an example of the hardware configuration of the information processing unit 120. The information processing unit 120 includes one or a plurality of processors 121 as operating means and a main memory device 122 and an auxiliary memory device 123 as a memory. Each of the processors 121 performs control of the image forming apparatus 100 and various types of processing by reading a program stored in the auxiliary memory device 123 into the main memory device 122 and executing the program. The processor 121 is, for example, a central processing unit (CPU), a microprocessing unit (MPU), a graphics processing unit (GPU), a digital signal processor (DSP), or the like. The main memory device 122 is, for example, a random access memory (RAM). The auxiliary memory device 123 is, for example, a magnetic disk device, a solid state drive (SSD), or the like. Furthermore, the information processing unit 120 includes an interface 124 for receiving various data such as data obtained by detection by a sensor from each unit of the image forming apparatus 100 and transmitting an instruction to each unit of the image forming apparatus 100. The configuration illustrated in FIG. 2 is merely an example. The configuration of the information processing unit 120 is not limited to the configuration example of FIG. 2.

In printing on paper by the image forming apparatus 100, operation settings set according to the type of paper are applied to an operation of the image forming unit 110. Operation settings include, for example, transfer voltage for transferring a toner image as an image forming material to paper, fixing temperature for fixing the toner image to the paper, and the like. For paper that is typically used and paper that a user often uses, the information processing unit 120 holds setting values for operation settings set in advance for each type of paper. Information about the setting values is, for example, stored in the auxiliary memory device 123 illustrated in FIG. 2. The information processing unit 120 sets operation settings of the image forming unit 110 according to the type of printing target paper, based on the stored information about the setting values.

In the case where paper for which no setting values are held is used, acquiring setting values for the paper is needed to set operation settings of the image forming unit 110. The information processing unit 120 identifies setting values for paper to be used, based on held information about setting values. Specifically, clustering of paper is performed in advance based on information about properties (hereinafter, referred to as “property information”) of paper for which setting values are held (hereinafter, referred to as “registered paper”). Properties of paper include, for example, basis weight, thickness, smoothness, and the like. The information processing unit 120 identifies paper that has properties approximate to those of paper to be used, and presents setting values for the identified paper as setting values for the paper to be used. The user references the presented setting values and if the setting values are appropriate as the setting values for the paper to be used, applies the identified setting values to the paper to be used. In contrast, the user corrects the presented setting values if necessary and uses the corrected setting values as the setting values for the paper to be used. Property information and information indicating the result of clustering of paper (hereinafter, referred to as “clustering information”) are, for example, stored in the auxiliary memory device 123 illustrated in FIG. 2.

### <Clustering of Paper>

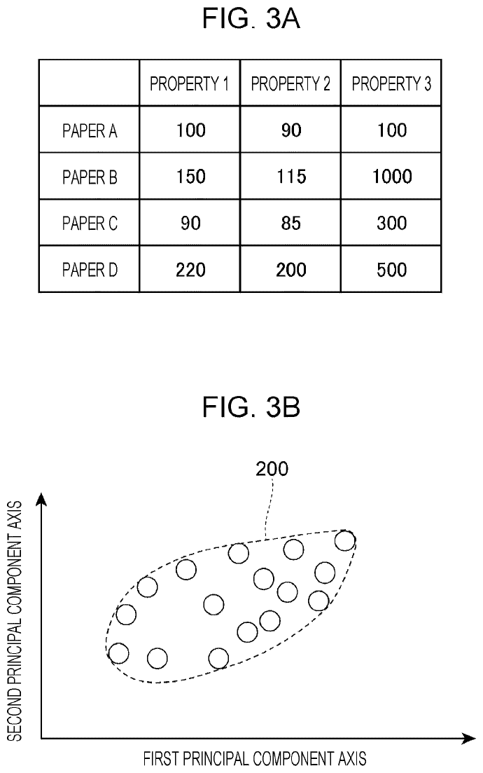

FIG. 3A is a diagram illustrating a table in which property information about paper is registered, and FIG. 3B is a scatter chart illustrating an example of a result of clustering of paper. Clustering of paper by the information processing unit 120 will be described with reference to FIGS. 3A and 3B.

In the table (hereinafter, referred to as a “property information table”) illustrated in FIG. 3A, property information about paper for which setting values are held in the information processing unit 120 is registered. For example, property information is obtained by measuring, using a measuring instrument or a measuring device, the basis weight, thickness, and the like of target paper. In the illustrated example, four types of paper (paper A to D) are indicated, and three types of properties (properties 1 to 3) are indicated. However, the number of types of paper and the number of types of properties registered in the property information table are not limited to the example illustrated in FIG. 3A. The property information table is, for example, stored in the auxiliary memory device 123 illustrated in FIG. 2.

The information processing unit 120 performs, using a model based on machine learning without a teacher, principal component analysis of a data set of property information for each type of paper such as the property information table illustrated in FIG. 3A. In the principal component analysis, property information about each type of paper is synthesized into a plurality of principal components. The information processing unit 120 creates a scatter chart as illustrated in FIG. 3B, based on results of the principal component analysis. In the illustrated example, the property information is synthesized into two principal components (first principal component and second principal component). The scatter chart is expressed as a graph in which the first principal component is represented on the horizontal axis and the second principal component is represented on the vertical axis. Multiple properties with a specific ratio are contributed to each of the principal components. For example, a specific contribution ratio, such as 60% of property 1, 40% of property 2, and 15% of property 3, is specified for the first principal component.

In the scatter chart illustrated in FIG. 3B, distribution of multiple types of paper based on properties is indicated. In a space indicated by the scatter chart (clustering space), types of paper corresponding to points close to each other have properties similar to each other. In FIG. 3B, a range 200 enclosed by a broken line (hereinafter, referred to as a “registered property range 200”) is a learning data space in which principal component analysis has been performed. That is, points corresponding to paper used for learning on a machine learning model are positioned within the registered property range 200. In FIG. 3B, a plurality of white circles within the registered property range 200 represent points indicating paper, and the position of each of the white circles in the scatter chart corresponds to properties of paper indicated by the white circle. Paper used for model learning is registered paper.

### <Identifying Setting Values for Operation Settings>

A case where information about setting values for operation settings for paper as a target of printing by the image forming apparatus 100 is not held will be considered. In this case, the information processing unit 120 sets new setting values for the printing target paper, based on properties of the printing target paper and clustering information about registered paper.

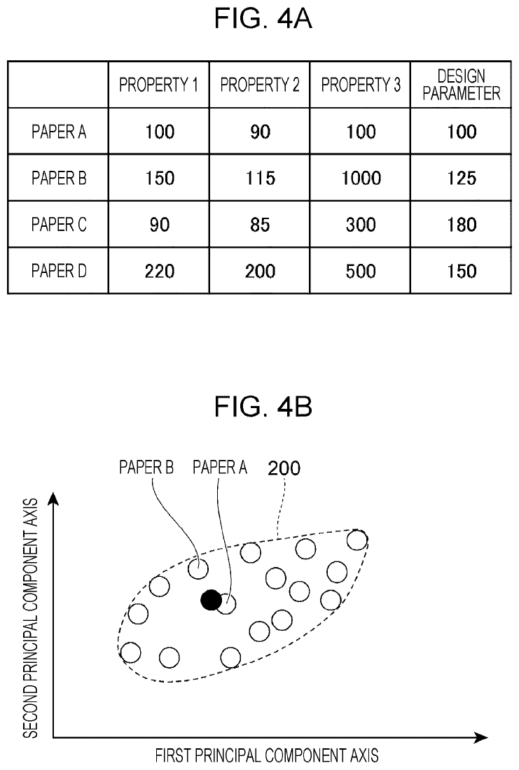

FIG. 4A is a diagram illustrating a property information table, and FIG. 4B is a scatter chart illustrating a result of clustering. In the property information table illustrated in FIG. 4A, each type of paper is associated with property information about the paper and a setting value for an operation setting used when printing is performed. In the example illustrated in FIG. 4A, a setting value is associated with paper. In actuality, however, setting values for multiple operation settings used when printing is performed are associated with paper. Specifically, for example, transfer voltage as an operation setting is associated with paper in a transfer process, and fixing temperature as an operation setting is associated with paper in a fixing process.

The information processing unit 120 acquires property information about printing target paper and synthesizes the acquired property information into each principal component by the principal component analysis described above with reference to FIG. 3B. In this example, the property information about the printing target paper is synthesized into the first principal component and the second principal component. The information processing unit 120 identifies the position of the printing target paper in the scatter chart, based on the acquired information about the principal components, as illustrated in FIG. 4B. In FIG. 4B, a black circle represents a point representing the printing target paper.

In the case where information about a setting value for an operation setting for the printing target paper is held in the information processing unit 120, the position of the black circle matches the position of one of the white circles in the scatter chart. In contrast, in the case where information about a setting value for an operation setting for the printing target paper is not held in the information processing unit 120, the position of the black circle does not match the position of any of the white circles, as illustrated in FIG. 4B. In this case, the information processing unit 120 selects, from among multiple types of registered paper, a type of paper whose properties are closest to those of the printing target paper, and sets a setting value for an operation setting for the selected registered paper as a setting value for an operation setting for the printing target paper. Paper whose properties are closest to those of the printing target paper is paper corresponding to the white circle whose position is closest to the position of the black circle in the scatter chart illustrated in FIG. 4B. For example, Euclidean distance or Manhattan distance is used for calculation of the distance between a black circle and a white circle in a scatter chart. In the example illustrated in FIG. 4B, since the position of the white circle corresponding to paper A is closest to the position of the black circle, the information processing unit 120 sets a setting value for an operation setting for the paper A as a setting value for an operation setting for the printing target paper.

### <Ui Screen>

The information processing unit 120 presents the information about the operation setting for the printing target paper identified as described above to the user via a UI screen displayed on the display unit 130. The information processing unit 120 is capable of receiving an operation on the UI screen by the user to change an operation setting.

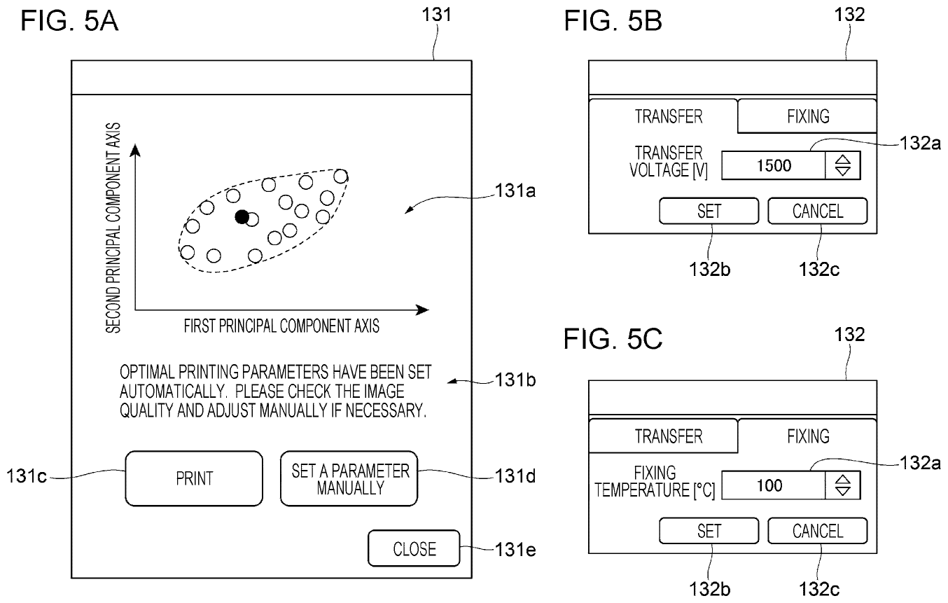

FIG. 5A is a diagram illustrating a basic screen, FIG. 5B is a diagram illustrating an example of an operation screen for receiving a change of an operation setting, and FIG. 5C is a diagram illustrating another example of the operation screen for receiving a change of an operation setting. The basic screen illustrated in FIG. 5A is displayed on the display unit 130, for example, when a printing instruction for printing target paper for which setting values for operation settings are not held is provided. When the user wishes to perform an operation to enter a setting value for an operation setting, the basic screen illustrated in FIG. 5A is transitioned to the operation screens illustrated in FIGS. 5B and 5C, and the operation screens illustrated in FIGS. 5B and 5C are displayed on the display unit 130.

A basic screen 131 illustrated in FIG. 5A is a screen that presents clustering information described above with reference to FIGS. 3 and 4 and receives an instruction to perform printing on printing target paper. On the basic screen illustrated in FIG. 5A, a scatter chart display part 131a, a message display part 131b, a print button 131c, a screen change button 131d, and an exit button 131e are displayed.

In the scatter chart display part 131a, a scatter chart indicating results of principal component analysis created by the information processing unit 120, for example, as illustrated in FIG. 4B, is displayed. By referencing the scatter chart displayed in the scatter chart display part 131a, the user is able to determine whether or not paper on which the user wishes to perform printing is registered paper and whether or not the paper is positioned within the registered property range 200 (see FIG. 3B and FIG. 4B) and determine the extent of similarity between properties of the paper on which the user wishes to perform printing and properties of registered paper (distance in the scatter chart) and the like.

In the message display part 131b, a message regarding setting values for operation settings for printing target paper (in FIG. 5A, described as “printing parameters”) is displayed. In the example illustrated in FIG. 4A, a message “Optimal printing parameters have been set automatically. Please check the image quality and adjust manually if necessary.”, which indicates that setting values have been automatically set, is displayed. The setting values set at this time are setting values for the registered paper (in the example illustrated in FIG. 4B, paper A) whose properties are closest to properties of the printing target paper in the scatter chart.

The print button 131c, the screen change button 131d, and the exit button 131e are button objects. When the print button 131c is selected, printing processing by the image forming unit 110 is performed. A character string “print” is indicated on the print button 131c. When the screen change button 131d is selected, display on the display unit 130 is transitioned to the operation screen for changing an operation setting. A character string “Set a parameter manually” is indicated on the screen change button 131d. When the exit button 131e is selected, the basic screen 131 is closed, and reception of an operation for printing ends. A character string “Close” is indicated on the exit button 131e.

An operation screen 132 illustrated in FIGS. 5B and 5C is a screen to be used by the user to change setting values for operation settings determined by the information processing unit 120. A setting value display part 132a, a set button 132b, and an exit button 132c are displayed on the operation screen 132. By a tab selection operation on the operation screen 132, the user is able to switch between types of operation settings displayed. In the examples illustrated in FIGS. 5B and 5C, switching between the operation setting in the transfer process and the operation setting in the fixing process is able to be performed.

A text box is provided in the setting value display part 132a. The current setting value for an operation setting specified by tab selection is displayed in this text box. In the example illustrated in FIG. 5B, the setting value for transfer voltage, which is an operation setting in the transfer process, is 1500 V. The user is able to change the setting value for the transfer voltage by rewriting display in the text box (editing operation). Similarly, in the example illustrated in FIG. 5C, the setting value for the fixing temperature, which is an operation setting in the fixing process, is 100 degrees Celsius. The user is able to change the setting value for the fixing temperature by rewriting display in the text box.

The set button 132b and the exit button 132c are button objects. When the set button 132b is selected (approval operation), a value indicated in the setting value display part 132a is confirmed to be the setting value for the operation setting. A character string “set” is indicated on the set button 132b. When the exit button 132c is selected, the operation screen 132 is closed, and reception of manual setting for the operation setting ends. A character string “cancel” is indicated on the exit button 132c.

### <Other Specific Examples of Setting Values for Operation Settings>

In the examples described above with reference to FIGS. 4 and 5, although setting values for operation settings for paper on which the user wishes to perform printing are not held, properties of the paper are positioned within the registered property range 200 (see FIGS. 3B and 4B). Next, a case where properties of paper on which the user wishes to perform printing are positioned outside the registered property range 200 will be described.

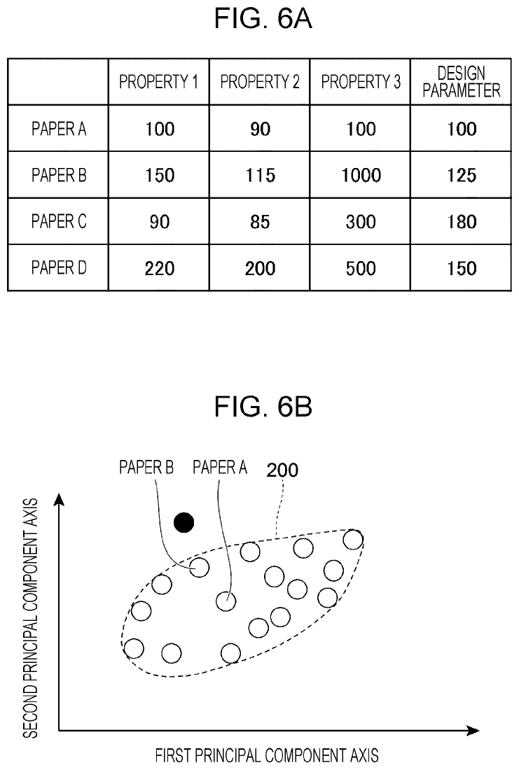

FIG. 6A is a diagram illustrating a property information table, and FIG. 6B is a scatter chart illustrating a result of clustering. In the property information table illustrated in FIG. 6A, each type of paper is associated with property information about the paper and a setting value for an operation setting used when printing is performed. In the example illustrated in FIG. 6A, a setting value is associated with paper. In actuality, however, setting values for multiple operation settings used when printing is performed are associated with paper. Specifically, for example, transfer voltage is associated with paper as an operation setting in the transfer process, and fixing temperature is associated with paper as an operation setting in the fixing process.

The information processing unit 120 acquires property information about printing target paper and synthesizes the acquired property information into each principal component by the principal component analysis described above with reference to FIG. 3B. In this example, the property information about the printing target paper is synthesized into the first principal component and the second principal component. The information processing unit 120 identifies the position of the printing target paper in the scatter chart, based on the acquired information about the principal components, as illustrated in FIG. 6B. In FIG. 6B, a black circle represents a point representing the printing target paper.

In the example illustrated in FIG. 6B, the position of the black circle does not match the position of any white circle and the black circle is positioned outside the registered property range 200. In this case, the information processing unit 120 is unable to determine a setting value for an operation setting for the printing target paper. Thus, the information processing unit 120 identifies a setting value as a reference for the printing target paper (hereinafter, referred to as a “reference value”). In this example, a type of paper whose properties are closest to those of the printing target paper is selected from among multiple types of registered paper, and a setting value for an operation setting for the selected registered paper is defined as a reference value for the printing target paper. Paper whose properties are closest to those of the printing target paper is paper corresponding to the white circle whose position is closest to the position of the black circle in the scatter chart illustrated in FIG. 6B. In the example illustrated in FIG. 6B, since the position of the white circle corresponding to paper B is closest to the position of the black circle, the information processing unit 120 defines a setting value for an operation setting for the paper B as a reference value for the printing target paper.

### <Ui Screen>

The information processing unit 120 presents the information about the operation setting for the printing target paper identified as described above to the user via the UI screen displayed on the display unit 130. The information processing unit 120 is capable of receiving an operation on the UI screen by the user to change an operation setting.

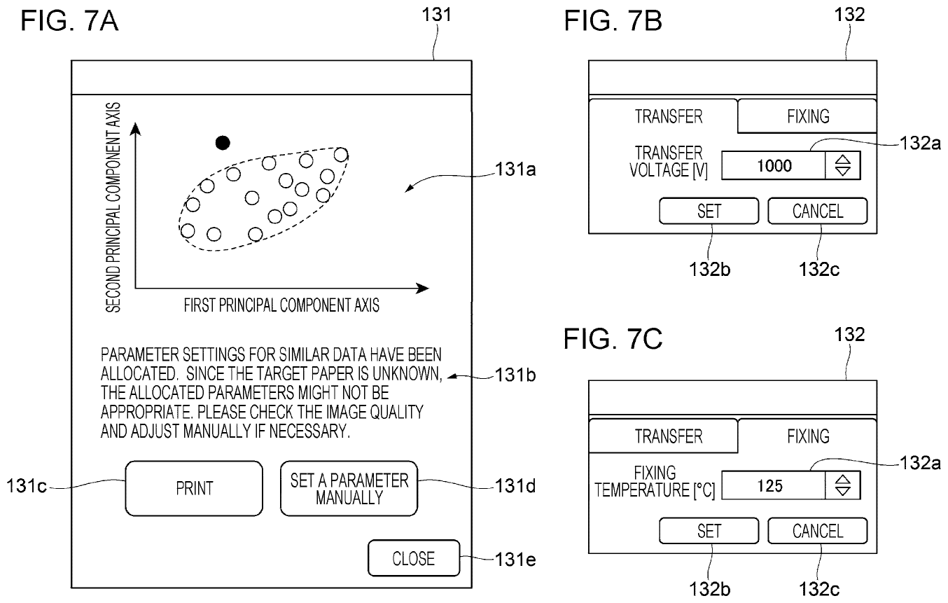

FIG. 7A is a diagram illustrating a basic screen, FIG. 7B is a diagram illustrating an example of an operation screen for receiving a change of an operation setting, and FIG. 7C is a diagram illustrating another example of the operation screen for receiving a change of an operation setting. The basic screen illustrated in FIG. 7A is displayed on the display unit 130, for example, when a printing instruction for printing target paper for which setting values for operation settings are not held is provided. When the user wishes to perform an operation to enter a setting value for an operation setting, the basic screen illustrated in FIG. 7A is transitioned to the operation screens illustrated in FIGS. 7B and 7C, and the operation screens illustrated in FIGS. 7B and 7C are displayed on the display unit 130.

The basic screen 131 illustrated in FIG. 7A is similar to the basic screen illustrated in FIG. 5A. The scatter chart display part 131a, the message display part 131b, the print button 131c, the screen change button 131d, and the exit button 131e are displayed on the basic screen 131 illustrated in FIG. 7A. On the basic screen 131 illustrated in FIG. 7A, a message indicating that reference values have been allocated is displayed in the message display part 131b. In the example illustrated in FIG. 7A, a message “Parameter settings for similar data have been allocated. Since the target paper is unknown, the allocated parameters might not be appropriate. Please check the image quality and adjust manually if necessary.” is displayed. Reference values set at this time are setting values for the registered paper B whose properties are closest to those of the printing target paper in the scatter chart.

The operation screen 132 illustrated in FIGS. 7B and 7C is similar to the operation screen 132 illustrated in FIGS. 5B and 5C. The setting value display part 132a, the set button 132b, and the exit button 132c are displayed on the operation screen 132 illustrated in FIGS. 7B and 7C. A text box is provided in the setting value display part 132a. A reference value for an operation setting specified by tab selection is displayed in this text box. In the example illustrated in FIG. 7B, the setting value for the transfer voltage, which is an operation setting in the transfer process, is 1000 V. The user is able to enter the setting value for the transfer voltage by rewriting display in the text box (editing operation). Similarly, in the example illustrated in FIG. 7C, the setting value for the fixing temperature, which is an operation setting in the fixing process, is 125 degrees Celsius. The user is able to enter the setting value for the fixing temperature by rewriting display in the text box.

### <Operation of Information Processing Unit 120>

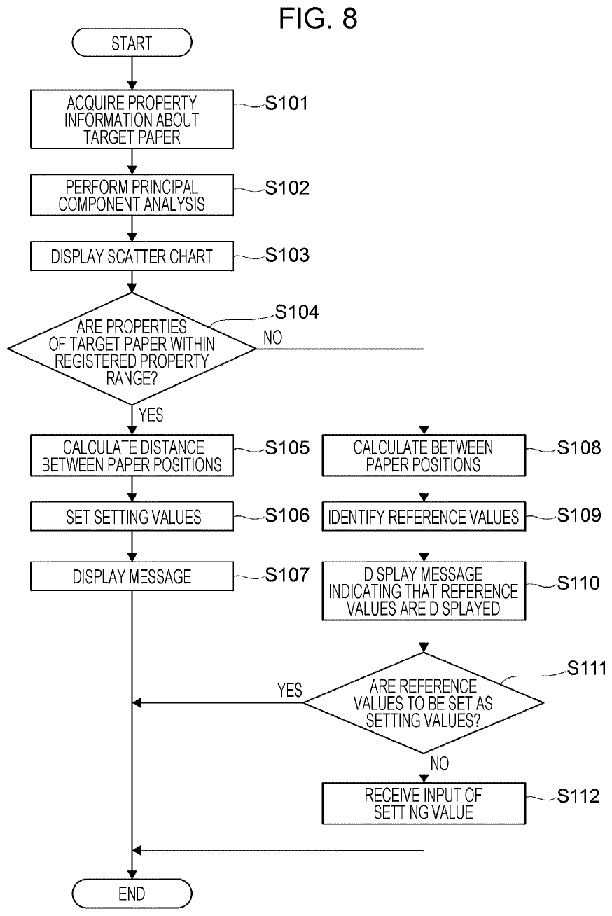

FIG. 8 is a flowchart illustrating an operation of the information processing unit 120. The information processing unit 120 performs in advance processing such as creation of a property information table and principal component analysis for paper for which setting values for operation settings are held and holds various data of the processing results. The information mentioned above is, for example, stored in the auxiliary memory device 123 illustrated in FIG. 2. Furthermore, property information about printing target paper is measured in advance by the user by using a measuring instrument or a measuring device.

The information processing unit 120 receives an input operation by the user and acquires property information about printing target paper (hereinafter, referred to as “target paper”) (S101). Then, the information processing unit 120 performs principal component analysis of the acquired property information (S102), and creates a scatter chart and displays the scatter chart on the display unit 130 (S103). Next, in the case where properties of the target paper are positioned within the registered property range 200 in the scatter chart displayed on the display unit 130 (YES in S104), the information processing unit 120 calculates the distance between the target paper and registered paper in the scatter chart (S105). The information processing unit 120 sets setting values for operation settings for the registered paper whose position is closest to the position of the target paper as setting values for operation settings for the target paper (S106), and displays a message (see FIG. 5A) indicating that setting values have been automatically set on the display unit 130 (S107). In this case, if an exit operation is performed without the user performing an operation for changing a setting value, the automatically set setting values are confirmed to be the setting values for the target paper, and the process ends.

In contrast, in the case where the properties of the target paper are positioned outside the registered property range 200 in the scatter chart displayed on the display unit 130 (NO in S104), the information processing unit 120 calculates the distance between the target paper and registered paper in the scatter chart (S108). Then, the information processing unit 120 sets setting values for operation settings for the registered paper whose position is closest to the position of the target paper as reference values for operation settings for the target paper (S109), and displays on the display unit 130a message (see FIG. 7A) indicating that the reference values for the target paper are displayed (S110). In the case where the information processing unit 120 receives a user operation for providing an instruction to set the reference values as the setting values for the target paper (YES in S111), the information processing unit 120 confirms the reference values to be the setting values, and the process ends. In contrast, in the case where a user operation for changing a reference value is performed, the information processing unit 120 does not set the reference values as the setting values for the target paper (NO in S111), receives input of a setting value by a user operation (S112), and confirms the input value as a setting value for the target paper. Then, the process ends.

The exemplary embodiment of the present disclosure has been described above. However, the technical scope of the present disclosure is not limited to the exemplary embodiment described above. For example, although the registered property range 200 in the scatter chart is indicated by a broken line on the basic screen 131 illustrated in FIGS. 5A and 7A in the exemplary embodiment described above, the registered property range 200 may be displayed visibly in various display manners, such as a manner in which the color of the registered property range 200 is different from colors of the other parts.

Furthermore, although the operation screen 132 for allowing the user to enter setting values is provided separately from the basic screen 131 in the exemplary embodiment described above, the basic screen 131 may be able to receive an operation for entering setting values. Furthermore, a mark indicating target paper (indicated by a black circle in FIGS. 5A and 7A) may be displayed in different manners between the case where properties of the target paper are positioned within the registered property range 200 and the case where the properties of the target paper are positioned outside the registered property range 200.

Furthermore, although properties of registered paper closest to those of target paper are used as reference values in the case where the properties of the target paper are positioned outside the registered property range 200 in the exemplary embodiment described above, properties of other registered paper may be presented as reference values. Furthermore, properties of multiple types of registered paper may be presented as reference values. Various changes and replacement of configuration may be included in the present disclosure as long as they do not depart from the scope of the technical idea of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising: a memory configured to store property information about one or a plurality of types of recording media; and one or a plurality of processors configured to: acquire property information about a target recording medium; display, on a display, a scatter chart indicating distribution of properties of the recording media for which the property information is stored in the memory and properties of the target recording medium; and display, on the same screen as a screen on which the scatter chart is displayed or on a screen different from the screen on which the scatter chart is displayed, an operation setting of an image forming apparatus for one of the recording media indicated in the scatter chart.

(((2)))

The information processing system according to (((1))), wherein the one or the plurality of processors are configured to, in a case where the properties of the target recording medium are positioned within a range containing the properties of the recording media for which the property information is stored in the memory in the distribution of the properties indicated in the scatter chart, display an operation setting of the image forming apparatus for one of the recording media positioned within the range.

(((3)))

The information processing system according to (((2))), wherein the one or the plurality of processors are configured to display an operation setting of the image forming apparatus for a recording medium whose properties are closest to the properties of the target recording medium among the recording media positioned within the range in the scatter chart.

(((4)))

The information processing system according to (((2))) or (((3))), wherein the one or the plurality of processors are configured to, in a case where the properties of the target recording medium are positioned outside the range in the scatter chart, display an operation setting of the image forming apparatus for one of the recording media positioned within the range.

(((5)))

The information processing system according to any one of (((1))) to (((4))), wherein the one or the plurality of processors are configured to visibly display a range containing the properties of the recording media for which the property information is stored in the memory in the distribution of the properties indicated in the scatter chart.

(((6)))

The information processing system according to (((5))), wherein the one or the plurality of processors are configured to display a point plotted in the scatter chart based on the properties of the target recording medium in such a manner that a case where the point is positioned within the range in the scatter chart and a case where the point is positioned outside the range in the scatter chart are distinguished from each other.

(((7)))

The information processing system according to any one of (((1))) to (((6))), wherein the one or the plurality of processors are configured to, when receiving an approval operation by a user, set the displayed operation setting as an operation setting for the target recording medium.

(((8)))

The information processing system according to (((7))), wherein the one or the plurality of processors are configured to receive an editing operation by the user for the displayed operation setting; and when receiving the approval operation by the user for the edited operation setting, set the edited operation setting as the operation setting for the target recording medium.

(((9)))

An image forming apparatus comprising:
an image forming unit configured to form an image on a recording medium; and
the information processing system according to any one of (((1))) to (((8))).
   (((10)))

A program for causing a computer of an image forming apparatus including an image forming unit configured to form an image on a recording medium and the computer configured to control an operation of the image forming unit, to execute: a function for acquiring property information about a target recording medium; a function for displaying, on a display, a scatter chart indicating distribution of properties of recording media for which property information is stored in a memory of the computer and properties of the target recording medium; and a function for displaying, on the same screen as a screen on which the scatter chart is displayed or on a screen different from the screen on which the scatter chart is displayed, an operation setting of the image forming apparatus for one of the recording media indicated in the scatter chart.

What is claimed is:

1. An information processing system comprising:
a memory configured to store property information about one or a plurality of types of recording media; and
one or a plurality of processors configured to:
acquire property information about a target recording medium;
display, on a display, a scatter chart indicating distribution of properties of the recording media for which the property information is stored in the memory and properties of the target recording medium; and
display, on the same screen as a screen on which the scatter chart is displayed or on a screen different from the screen on which the scatter chart is displayed, an operation setting of an image forming apparatus for one of the recording media indicated in the scatter chart.

2. The information processing system according to claim 1, wherein the one or the plurality of processors are configured to, in a case where the properties of the target recording medium are positioned within a range containing the properties of the recording media for which the property information is stored in the memory in the distribution of the properties indicated in the scatter chart, display an operation setting of the image forming apparatus for one of the recording media positioned within the range.

3. The information processing system according to claim 2, wherein the one or the plurality of processors are configured to display an operation setting of the image forming apparatus for a recording medium whose properties are closest to the properties of the target recording medium among the recording media positioned within the range in the scatter chart.

4. The information processing system according to claim 2, wherein the one or the plurality of processors are configured to, in a case where the properties of the target recording medium are positioned outside the range in the scatter chart, display an operation setting of the image forming apparatus for one of the recording media positioned within the range.

5. The information processing system according to claim 1, wherein the one or the plurality of processors are configured to visibly display a range containing the properties of the recording media for which the property information is stored in the memory in the distribution of the properties indicated in the scatter chart.

6. The information processing system according to claim 5, wherein the one or the plurality of processors are configured to display a point plotted in the scatter chart based on the properties of the target recording medium in such a manner that a case where the point is positioned within the range in the scatter chart and a case where the point is positioned outside the range in the scatter chart are distinguished from each other.

7. The information processing system according to claim 1, wherein the one or the plurality of processors are configured to, when receiving an approval operation by a user, set the displayed operation setting as an operation setting for the target recording medium.

8. The information processing system according to claim 7, wherein the one or the plurality of processors are configured to:
receive an editing operation by the user for the displayed operation setting; and
when receiving the approval operation by the user for the edited operation setting, set the edited operation setting as the operation setting for the target recording medium.

9. An image forming apparatus comprising:
an image forming unit configured to form an image on a recording medium; and
the information processing system according to claim 1.

10. An image forming apparatus comprising:
an image forming unit configured to form an image on a recording medium; and
the information processing system according to claim 2.

11. An image forming apparatus comprising:
an image forming unit configured to form an image on a recording medium; and
the information processing system according to claim 3.

12. An image forming apparatus comprising:
an image forming unit configured to form an image on a recording medium; and
the information processing system according to claim 4.

13. An image forming apparatus comprising:
an image forming unit configured to form an image on a recording medium; and
the information processing system according to claim 5.

14. An image forming apparatus comprising:
an image forming unit configured to form an image on a recording medium; and
the information processing system according to claim 6.

15. An image forming apparatus comprising:
an image forming unit configured to form an image on a recording medium; and
the information processing system according to claim 7.

16. An image forming apparatus comprising:
an image forming unit configured to form an image on a recording medium; and
the information processing system according to claim 8.

17. A non-transitory computer readable medium storing a program causing a computer of an image forming apparatus to execute a process, the image forming apparatus including an image forming unit configured to form an image on a recording medium, and the computer configured to control an operation of the image forming unit, the process comprising:
acquiring property information about a target recording medium;
displaying, on a display, a scatter chart indicating distribution of properties of recording media for which property information is stored in a memory of the computer and properties of the target recording medium; and
displaying, on the same screen as a screen on which the scatter chart is displayed or on a screen different from the screen on which the scatter chart is displayed, an operation setting of the image forming apparatus for one of the recording media indicated in the scatter chart.

18. An information processing system comprising:
storage means for storing property information about one or a plurality of types of recording media; and
means for acquiring property information about a target recording medium;
means for displaying, on a display, a scatter chart indicating distribution of properties of the recording media for which the property information is stored in the storage means and properties of the target recording medium; and
means for displaying, on the same screen as a screen on which the scatter chart is displayed or on a screen different from the screen on which the scatter chart is displayed, an operation setting of an image forming apparatus for one of the recording media indicated in the scatter chart.
